(19) United States
(12) Patent Application Publication
(10) Pub. No.: US 2026/0106660 A1
(43) Pub. Date: Apr. 16, 2026

(54) METHOD AND APPARATUS FOR INITIAL BEAM PAIRING BEFORE UNICAST LINK ESTABLISHMENT IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/418,482

(22) Filed: Dec. 12, 2025

Related U.S. Application Data
(63) Continuation of application No. PCT/KR2024/008033, filed on Jun. 12, 2024.

(30) Foreign Application Priority Data
Jun. 12, 2023 (KR) 10-2023-0074758
Jun. 11, 2024 (KR) 10-2024-0075706

(51) Int. Cl. H04B 7/06; H04L 27/26; H04W 72/25

(52) U.S. Cl. CPC H04B 7/06952; H04L 27/261; H04W 72/25

(57) ABSTRACT

Embodiments relate to a method and an apparatus for initial beam pairing before unicast link establishment in sidelink communication. A transmitting terminal according to one embodiment transmits a reference signal (RS) for beam pairing to a receiving terminal, and receives a beam reporting based on the transmitted reference signal from the receiving terminal. The transmitting terminal transmits a direct link establishment request (DCR) message to the receiving terminal based on the received beam reporting, and receives a direct link establishment accept (DCA) message from the receiving terminal in response to the transmitted direct link establishment request.

### CROSS-REFERENCE TO RELATED APPLICATIONS

This application is a continuation application of PCT International Application No. PCT/KR2024/008033 filed on Jun. 12, 2024 and entitled “METHOD AND APPARATUS FOR INITIAL BEAM PAIRING BEFORE UNICAST LINK ESTABLISHMENT IN SIDELINK COMMUNICATION,” which claims priority to and the benefit of Korean Patent Application No. 10-2023-0074758, filed on Jun. 12, 2023, and Korean Patent Application No. 10-2024-0075706, filed on Jun. 11, 2024, the disclosures of which are incorporated herein by reference in their entireties.

### TECHNICAL FIELD

The present disclosure relates to 3GPP 5G sidelink communication.

### BACKGROUND ART

Sidelink (SL) refers to a method of performing direct communication between user equipments (UEs) by establishing a direct link therebetween without passing through a base station.

Vehicle-to-everything (V2X) refers to communication for exchanging information with other vehicles, pedestrians, infrastructure-enabled objects, and the like via a sidelink. That is, V2X may be classified into four types, such as vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

Meanwhile, as an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, eMBB is a next-generation mobile communication scenario that has characteristics such as High Spectrum Efficiency, High User Experienced Data Rate, and High Peak Data Rate. URLLC is a next-generation mobile communication scenario characterized by features such as Ultra Reliability, Ultra Low Latency, and Ultra High Availability (e.g., V2X, Emergency Service, Remote Control). mMTC is a next-generation mobile communication scenario characterized by features such as Low Cost, Low Energy, Short Packet, and Massive Connectivity (e.g., IoT).

### DISCLOSURE OF INVENTION

### Technical Problem

The present disclosure is to provide a method and an apparatus for initial beam pairing before unicast link establishment between terminals for sidelink communication in a wireless communication system.

### Solution to Problem

An embodiment of the present specification provides a method in which, in sidelink (SL) communication, a transmitting terminal transmits a reference signal (RS) for beam pairing to a receiving terminal, and receives a beam reporting based on the transmitted reference signal from the receiving terminal. The transmitting terminal transmits a direct link establishment request (DCR) message to the receiving terminal based on the received beam reporting, and receives a direct link establishment accept (DCA) message from the receiving terminal in response to the transmitted direct link establishment request.

Further, an embodiment of the present specification provides a method in which, in sidelink (SL) communication, a receiving terminal receives a reference signal (RS) for beam pairing from a transmitting terminal, and transmits a beam reporting based on the received reference signal to the transmitting terminal. The receiving terminal receives a direct link establishment request (DCR) message based on the transmitted beam reporting from the transmitting terminal, and transmits a direct link establishment accept (DCA) message to the transmitting terminal in response to the received direct link establishment request.

Further, an embodiment of the present specification provides a transmitting terminal for sidelink (SL) communication, comprising a control unit, and a memory unit storing instructions and being operably and electrically connectable to the control unit, wherein operations performed based on the instructions being executed by the control unit comprise: transmitting a reference signal (RS) for beam pairing, and receiving a beam reporting based on the transmitted reference signal. The operations further include transmitting a direct link establishment request (DCR) message based on the received beam reporting, and receiving a direct link establishment accept (DCA) message in response to the transmitted direct link establishment request.

Further, an embodiment of the present specification provides a receiving terminal for sidelink (SL) communication, comprising a control unit, and a memory unit storing instructions and being operably and electrically connectable to the control unit, wherein operations performed based on the instructions being executed by the control unit comprise: receiving a reference signal (RS) for beam pairing, and transmitting a beam reporting based on the received reference signal. The operations further include receiving a direct link establishment request (DCR) message based on the transmitted beam reporting, and transmitting a direct link establishment accept (DCA) message in response to the received direct link establishment request.

Meanwhile, the transmitting terminal may transmit a beam pairing response to the receiving terminal, and the direct link establishment request message may include the beam pairing response. In another example, the beam pairing response may be transmitted as a separate message before the transmission of the direct link establishment request message.

The direct link establishment request message may be transmitted (or received) based on a specific time offset.

The reference signal may be at least one of a sidelink-synchronization signal block (S-SSB), a sidelink channel state information-reference signal (CSI-RS), and a demodulation-reference signal (DM-RS) of a sidelink channel.

Furthermore, the reference signal may include identifier information of the transmitting terminal and/or the receiving terminal.

This specification describes technology targeting the 5G/5G-advanced system defined in 3GPP, but the techniques/concepts proposed in this specification may be applied to mobile communication systems other than 5G, such as LTE or a future 6G system.

### Advantageous Effects of Invention

According to the disclosure of the present specification, initial beam pairing and unicast link establishment for sidelink communication in the 3GPP 5G frequency range 2 (FR2) band can be performed efficiently.

### BRIEF DESCRIPTION OF DRAWINGS

FIG. 1 is a diagram illustrating an NR wireless communication system.

FIG. 2 illustrates a structure of a radio frame used in NR.

FIG. 3 illustrates a slot structure of an NR frame.

FIG. 4 illustrates an example of an NG-RAN architecture that supports a PC5 interface.

FIGS. 5A to 5B illustrate procedures for performing sidelink communication according to a sidelink resource allocation mode.

FIGS. 6A to 6B are examples of signaling for performing initial beam pairing and unicast link establishment according to an embodiment of the present specification.

FIGS. 7A to 7D illustrate examples of performing beam sweeping within an S-SSB transmission period according to an embodiment of the present specification.

FIGS. 8A to 8B illustrate examples where a standalone CSI-RS is transmitted in conjunction with S-SSB beam sweeping according to an embodiment of the present specification.

FIG. 9 illustrates an example where a sidelink slot is transmitted in a beam sweeping manner via six beams during one beam sweeping period according to an embodiment of the present specification.

FIG. 10 illustrates an example of a sidelink slot configuration according to an embodiment of the present specification.

FIG. 11 illustrates a wireless communication apparatus according to an embodiment of the present specification.

### MODE FOR THE INVENTION

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

The numerical values of the frequency range of the NR system may be changed. For example, FR1 may include a band from 410 MHz to 7125 MHz as in Table 1. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

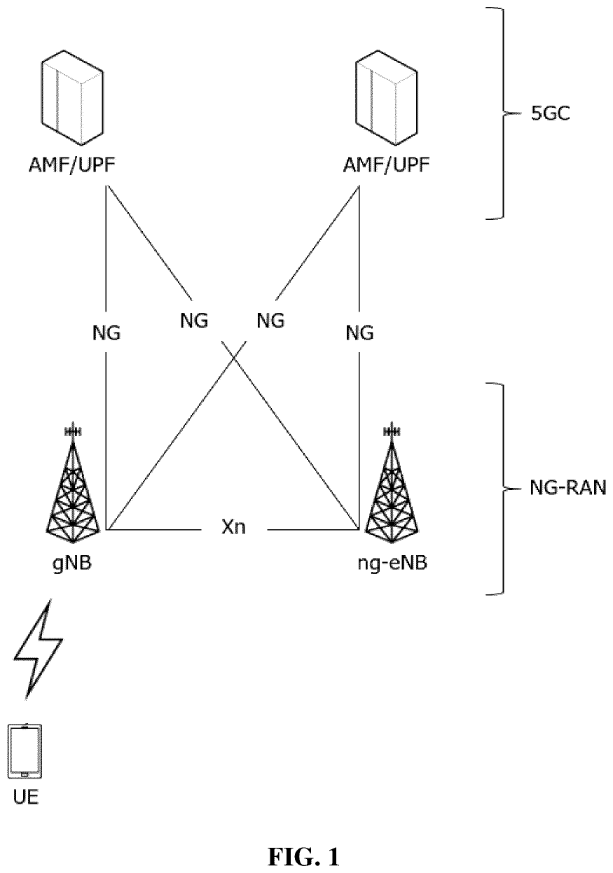

### FIG. 1 is a Diagram Illustrating an NR Wireless Communication System.

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

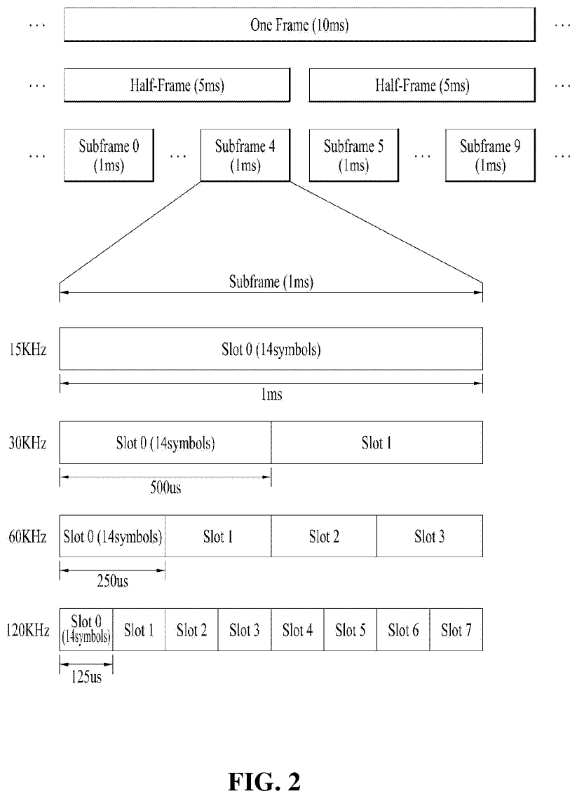

### FIG. 2 Illustrates a Structure of a Radio Frame Used in NR.

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| SCS(15*2^{u}) | N^{slot}_{symb} | N^{frame, u}ₛₗₒₜ | N^{subframe, u}ₛₗₒₜ |
|---|---|---|---|
| 15 KHz(u = 0) | 14 | 10 | 1 |
| 30 KHz(u = 1) | 14 | 20 | 2 |
| 60 KHz(u = 2) | 14 | 40 | 4 |
| 120 KHz(u = 3) | 14 | 80 | 8 |
| 240 KHz(u = 4) | 14 | 160 | 16 |

N^{slot}_{symb}: number of symbols in a slot
N^{frame, u}ₛₗₒₜ: number of slots in a frame
N^{subframe, u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM (A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

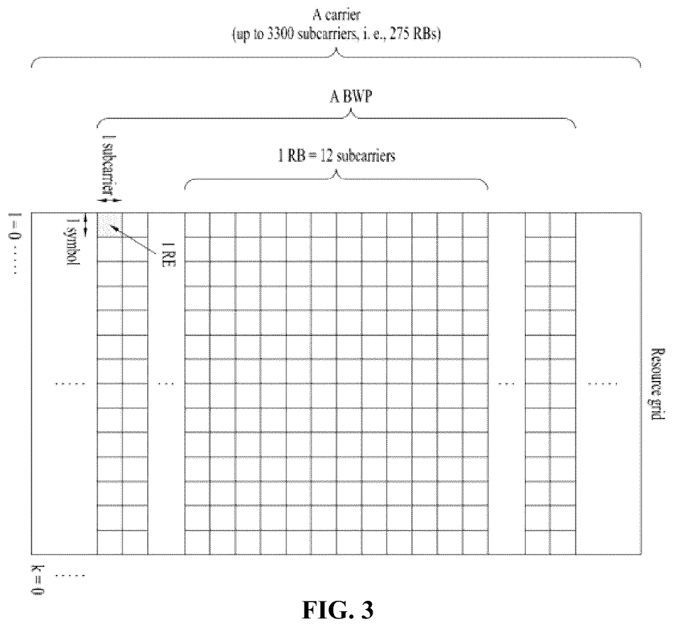

### FIG. 3 Illustrates a Slot Structure of an NR Frame.

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P)RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

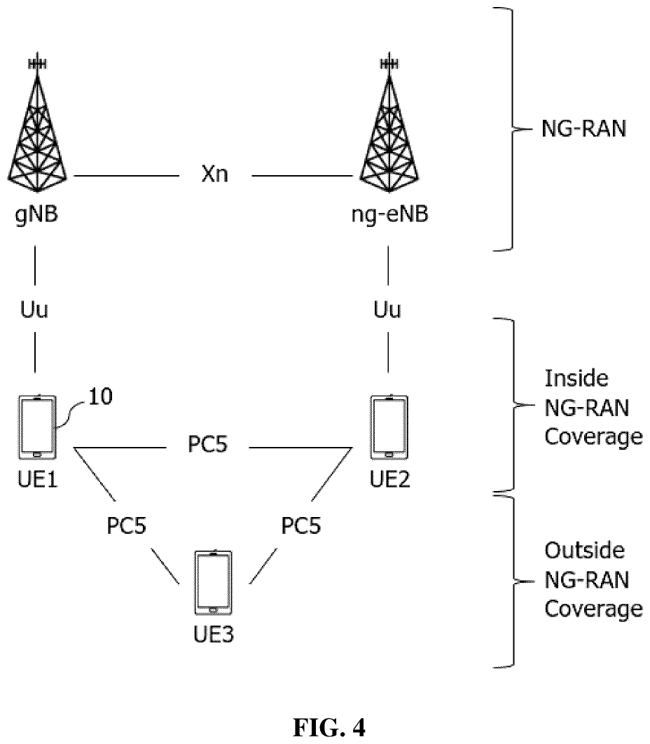

FIG. 4 Illustrates an Example of an NG-RAN Architecture that Supports a PC5 Interface.

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

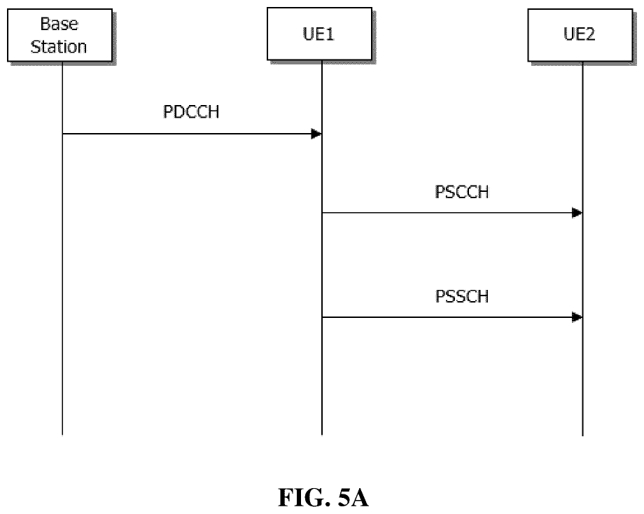

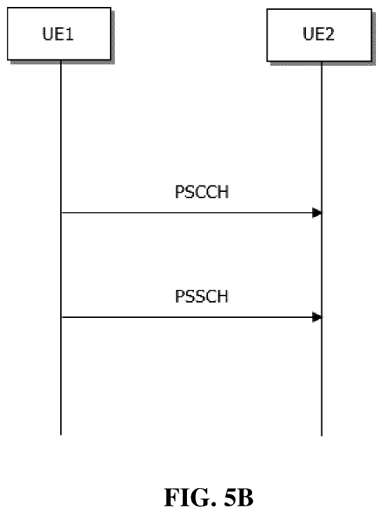

### FIGS. 5A to 5B Illustrate Procedures for Performing Sidelink Communication According to a Sidelink Resource Allocation Mode.

FIG. 5A illustrates a UE operation related to NR resource allocation mode 1, and FIG. 5b illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re) selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

Meanwhile, technology for performing initial beam pairing and unicast link establishment for sidelink communication in the frequency range 2 (FR2) band is currently under development. This specification proposes a procedure and detailed techniques for performing initial beam pairing before performing unicast link establishment. In particular, it proposes a reference signal (RS) and messages used for beam information delivery in the performance of the initial beam pairing operation, and a resource allocation method and/or operational method for transmitting the corresponding signal/data. Furthermore, when performing initial beam pairing before unicast link establishment, the receiving UE performs initial beam pairing without knowing whether the transmitting UE currently conducting the beam pairing procedure is the UE for unicast link establishment. Therefore, from the receiving UE's perspective, unnecessary beam pairing procedures may occur. This specification proposes a method for transmitting identifier information via a reference signal and message transmitted by a transmitting UE for initial beam pairing, in order to minimize the aforementioned unnecessary beam pairing procedures.

In 3GPP, discussions are underway regarding beam-related technologies for sidelink communication in the FR2 band, and Table 4 below shows a part of the related Agreements.

TABLE 4
Agreement (#112)
For sidelink beam management, RAN1 is to study
> how transmit beam(s) training and/or receive beam(s) training is performed
> whether and how spatial related information (e.g., TCI, QCL, beam ID, etc)
information could be identified
> the relationship between PC5 unicast link establishment and sidelink initial beam
pairing (e.g., whether initial beam pairing procedure starts before, during or after
sidelink unicast link establishment procedure.)
Agreement (#112b)
> RAN1 can study the following candidate procedure where initial beam pairing is
performed before sidelink unicast link establishment, including at least the following
steps and how to determine UE2:
> UE1 sends reference signals via different transmit beams
>> Note: multiple reference signals transmissions (e.g. repetitions) from each of the
beams can be studied
>> FFS when reference signals are sent
>> FFS applicable reference signal
> UE2 measures the reference signals and determines a UE1 transmit beam and/or a
UE2 receive beam
>> FFS: whether/how to determine a UE2 transmit beam
> UE2 indicates to UE1 the determined UE1 transmit beam
>> FFS how to indicate the determined transmit beam, including its feasibility
> UE1 and UE2 set up sidelink unicast link using the determined beam, following
existing link establishment procedure.
Agreement (#112b)
To study the feasibility of adapting S-SSB for initial beam pairing between UE1 and
UE2, at least the following can be considered.
> Whether/how to enable UE2 to identify UE1 (e.g., source ID) from UE1's S-SSB
transmission, to enable UE1 to identify the corresponding beam
measurement/reporting from UE2
> Mapping between S-SSB transmission/resource and beam related information
> Allocation of beam reporting resources respectively associated with different S-SSB
transmit beams
> Structure and contents of S-SSB
> Triggering and/or activation of S-SSB transmission, if needed
> Mechanism for S-SSB monitoring and reporting/responding
> Mechanism to mitigate/avoid the interference between overlapped S-SSB
transmissions from different UEs, including S-SSB transmission resources
> Potential impact to/from other UEs, and whether/how to avoid or mitigate this
impact
Agreement(#112b)
To study the feasibility of reusing SL CSI-RS for initial beam pairing, at least the
following enhancements can be considered.
> SL CSI-RS transmission with or without sidelink data transmission in the same slot
>> FFS: slot structure
> Mapping between SL CSI-RS transmission/resource and beam related information
> Periodic SL CSI-RS transmission, semi-persistent SL CSI-RS transmission, or
aperiodic SL CSI-RS transmission, with or without SCI indication
> Allocation of SL CSI-RS beam sweeping resources and if applicable, their
associated beam reporting resources
> Study the possibility to apply SL CSI-RS for initial beam pairing before, during or
after unicast link establishment
>> FFS: How to provide SL CSI-RS resource configuration
> Whether or how to mitigate/avoid the interference between overlapped SL CSI-RS
transmissions from different UEs
> SL CSI-RS transmission with or without repetition on transmit beams
Agreement (#113)
In the candidate procedure where initial beam pairing is performed before sidelink
unicast link establishment,
> In step 1,
>> the applicable reference signal is selected based on
>>> Alt 1-1: S-SSB or its modified format
>>> Alt 1-2: standalone SL CSI-RS or its modified format
>>> Alt 1-3: non-standalone SL CSI-RS
>>>> Note: standalone SL CSI-RS transmission means at least no accompanying
sidelink data (SL MAC SDU) transmissions in the same slot. FFS: accompanying
SCI(s) or SL MAC CE transmissions or PSFCH.
>>> Alt 1-4: PSCCH/PSSCH DMRS
>> the reference signals are sent
>>> Alt 2-0: aperiodically
>>> Alt 2-1: periodically
>>> Alt 2-2: semi-persistent with activation and deactivation
>>>>FFS details of activation/deactivation
>> FFS resources and resource allocation of reference signal
>> FFS: if CSI-RS is used, whether UE1 transmits other information associated with
the CSI-RS
> In step 2,
>> UE1's transmit beam and UE2's receive beam are determined by UE2 as the pair
with the RSRP measurement satisfying certain condition(s)
>>> FFS details of condition(s)
>>> FFS explicit or implicit determination of UE1 transmit beam by UE2
>> UE2's transmit beam is at least determined as the one corresponding to
determined UE2's receive beam, at least if beam correspondence is assumed
>>> FFS other scheme
> In step 3,
>> UE2's beam reporting is associated with determined UE1's transmit beam.
>>> FFS details of association
>>> FFS details of beam reporting
>>> Note: this does not preclude beam reporting in the link establishment message.
>> FFS: how UE1 determines its transmit beam if it receives different beam reporting
from different UEs
> FFS: whether/how to avoid unnecessary beam measurement and reporting from
multiple UEs;

This specification proposes a communication method for the case where an initial beam pairing operation is performed before unicast link establishment for sidelink (SL) communication. Preferably, it proposes an SL communication method for the case where an initial beam pairing operation is performed before unicast link establishment in the frequency range 2 (FR2) band.

In this specification, for convenience of description, UE1 is referred to as a UE that transmits data/signals in SL communication, and UE2 is referred to as a target UE that receives data/signals from UE1. Furthermore, a transmission beam used for data/signal transmission is referred to as a TX beam, and a reception beam used for data/signal reception is referred to as an RX beam.

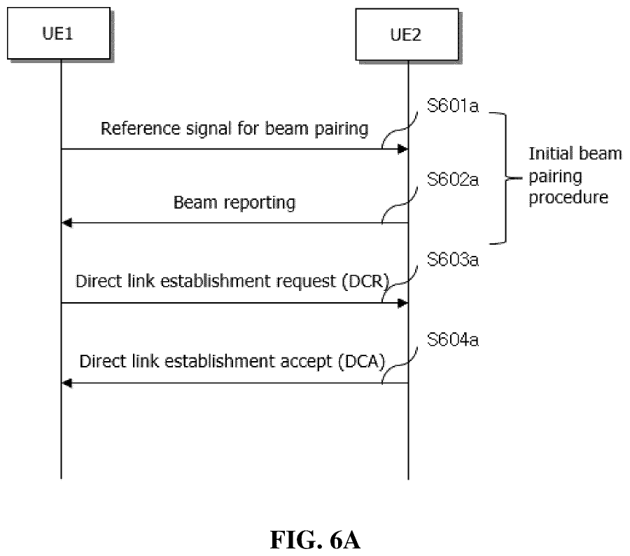

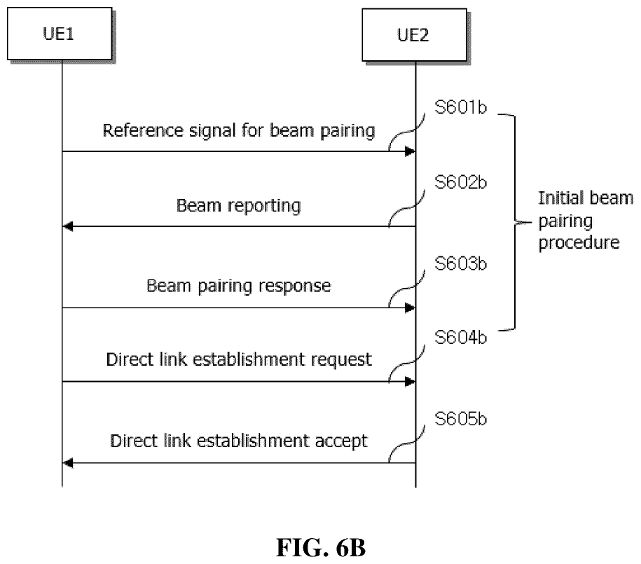

### FIGS. 6A to 6B are Examples of Signaling for Performing Initial Beam Pairing and Unicast Link Establishment According to an Embodiment of the Present Specification.

The initial beam pairing in FIGS. 6A to 6B is performed before the unicast link establishment is performed.

Referring to FIG. 6A, UE1 transmits a reference signal (RS) for beam pairing in the form of beam sweeping (S601a). Subsequently, UE2 performs measurement on the corresponding RSs transmitted with specific beams and, based on the received information, selects beam(s) to be used for SL communication. Thereafter, it reports the information of the corresponding beam(s) to UE1 (S602a). The initial beam pairing between UE1 and UE2 is completed by this signaling procedure. Subsequently, UE1 transmits a direct link establishment request (DCR) message to UE2 for unicast link establishment, using the TX beam(s) acquired through the beam pairing procedure (S603a). At this time, UE2 receives the DCR message using the RX beam(s) acquired through the initial beam pairing procedure.

UE2, upon successfully receiving the DCR message, transmits a direct link establishment accept (DCA) message to UE1 (S604a), through which the unicast link establishment procedure may be completed. The TX beam of UE2 and the RX beam of UE1 for the transmission and reception of the DCA message may be configured based on the beam information acquired through the beam pairing procedure.

In the procedure of FIG. 6A, the DCR message may be transmitted within a specific time offset after the beam reporting from UE2. For example, since a beam pair acquired by beam pairing may no longer be valid due to channel changes over time, the DCR message may be transmitted using the beam pair acquired through the beam pairing procedure within a specific time offset after the beam reporting. If the DCR message cannot be transmitted within the time offset, UE1 may perform the beam pairing procedure again.

In the procedure of FIG. 6A, UE2 may transmit the beam reporting within a specific time offset from the time when UE1's RS transmission for beam pairing has ended. For example, since the beam information measured by UE2 may no longer be valid due to channel changes over time after UE1's RS transmission for beam pairing, the beam reporting may be made based on the acquired beam-related information within a specific time offset after UE1's RS transmission for beam pairing. If UE2 performs beam reporting after the specific time offset, the information of the corresponding beam pair may be discarded and not used by UE1. Furthermore, if UE1 does not receive the beam reporting within the specific time offset, UE1 may transmit the RSs for beam pairing again. For example, this operation may be applied and operated when the RS transmission for beam pairing is transmitted in an aperiodic form or a semi-persistent form.

The specific time offset values may be used as fixed values in the system, or may be configured and operated as resource pool specific or SL specific. In an operation where a specific time offset value is configured, the offset value may be configured using signalings that may be used in the beam procedure. For example, it may be configured through a master information block (MIB), a system information block (SIB) transmitted via the physical sidelink broadcast channel (PSBCH) of the S-SSB, sidelink control information (SCI) of the physical sidelink control channel (PSCCH), the physical sidelink shared channel (PSSCH), the physical sidelink feedback channel (PSFCH), a medium access control-control element (MAC-CE), and/or Radio Resource Control (RRC), among others.

In the operation of FIG. 6A, the DCR message may include a beam pairing response message. In this case, UE2 recognizes that beam pairing with UE1 has succeeded regardless of unicast link establishment, and may utilize the beam pairing information in subsequent signaling procedures with UE1.

Meanwhile, FIG. 6B is an example of signaling where a beam pairing response message is added to the beam pairing procedure. This signaling may be transmitted when the initial beam pairing has been successfully completed (S603b). For reference, S601b, S602b, S604b, and S605b of FIG. 6B are signalings corresponding to S601a, S602a, S603a, and S604a of FIG. 6A, respectively, and may correspond to the contents of FIG. 6A described above.

The beam pairing response message may include all or part of the following information: beam information used by UE1 for transmission, beam information that UE2 should use, UE1's unicast Layer 2 (L2) ID or source L2 ID, UE1's application layer ID, UE2's unicast L2 ID or destination L2 ID, V2X service ID, UE1's L1 ID, or UE2's L1 ID.

The initial beam pairing response message may indicate transmission of a DCR message. In this case, UE2 may attempt to receive the DCR message after receiving the beam pairing response message. For example, it may start monitoring the PSCCH used for DCR message transmission. Furthermore, the beam pairing response message may include all or part of the information about the resource on which the DCR message is transmitted.

In the operation of the procedure of FIG. 6B, the operation where the next signal is transmitted within a period based on a specific time offset between signalings used in FIG. 6A may be operated in a simply applied, extended, and modified form. In one embodiment, if UE2 does not receive a beam pairing response within a specific time offset after transmitting the beam reporting, it may not attempt to receive the DCR message and may instead attempt to receive the RS for beam pairing from UE1. Alternatively, if UE2 receives the DCR message within a specific time offset after transmitting the beam reporting, even if a beam response is not received, it may determine that beam pairing will be completed and proceed with the subsequent procedure. If the DCR message is not received within the specific time offset after transmitting the beam reporting, it may no longer attempt to receive the DCR message and may instead attempt to receive the RS for beam pairing from UE1.

Furthermore, in the operation of the procedure of FIG. 6B, it can be configured and operated such that UE1 transmits the DCR message within a specific time offset after transmitting the beam pairing response. If the specific time offset is exceeded, UE1 may perform the beam pairing procedure again.

The specific time offset values may be used as fixed values in the system, or may be configured and operated as resource pool specific or SL specific. In an operation where a specific time offset value is configured, the offset value may be configured using signalings that may be used in the beam procedure. For example, it may be configured through an MIB, SIB transmitted via the PSBCH of the S-SSB, SCI of the PSCCH, PSSCH, PSFCH, MAC-CE, and/or RRC, among others.

In the example of FIG. 6A and/or FIG. 6B described above, the RS transmitted by UE1 may be an S-SSB, a channel state information-reference signal (SL CSI-RS), and/or a demodulation-reference signal (DM-RS) of the PSCCH and PSSCH. The RS may be one or more of the three aforementioned RSs.

In the example of FIG. 6A and/or FIG. 6B, since the beam pairing procedure is performed before unicast link establishment, UE2 does not know whether the reception information measured during the beam pairing process belongs to UE1, which is the target of unicast link establishment, until the DCR message is received. Therefore, unnecessary beam measurement occurs during the beam pairing process.

To minimize unnecessary beam measurement processes at UE2, the RS signal for beam pairing may include all or part of the following information: UE1's unicast L2 ID or source L2 ID, UE1's application layer ID, UE2's unicast L2 ID or destination L2 ID, V2X service ID, UE1's L1 ID, or UE2's L1 ID. Hereinafter in this specification, the ID information is referred to as identifier information.

As a container for transmitting the identifier information, transmission is possible for each RS in the following manner.

In the example of FIG. 6A and/or FIG. 6B, if the transmitted RS is an S-SSB, transmission is possible via one or a combination of more than one container among an MIB transmitted through the PSBCH within the S-SSB transmitted by UE1, a first SIB transmitted through a resource indicated by the MIB, a second SIB transmitted through a resource indicated by the MIB and the first SIB, a MAC-CE, or RRC. At this time, the SIB may be transmitted with an omni-beam. Alternatively, the SIB may be repeated on a slot or symbol basis and transmitted in a beam sweeping manner during SIB transmission for each resource unit. Alternatively, it may be frequency division multiplexed (FDM) on a different frequency resource in the same slot as the S-SSB and transmitted via beam sweeping based on the same beam as the S-SSB.

In the SIB transmission, the identifier information may be transmitted in the form of transmitting data using PSCCH and PSSCH instead of the SIB format, and the indication for the resources for the PSCCH and PSSCH may be applied in the same way as the indication method for the SIB resource information. At this time, the identifier information may be transmitted via SCI of the PSCCH, PSSCH, or MAC-CE.

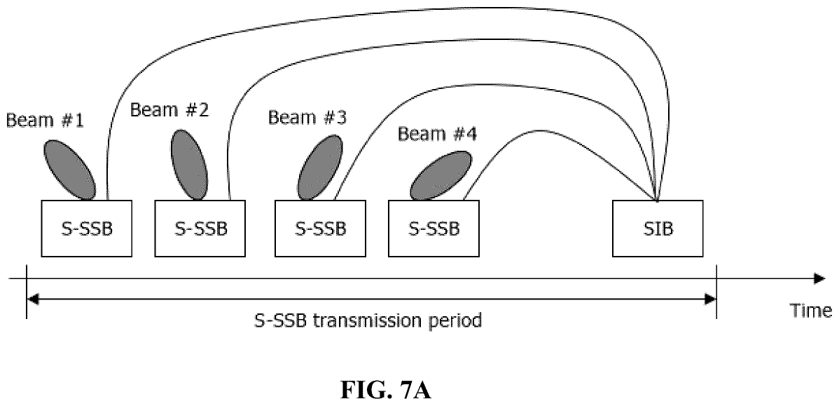

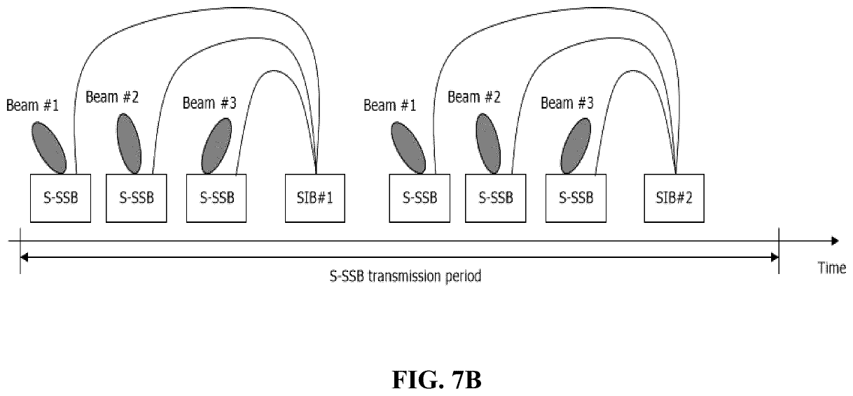

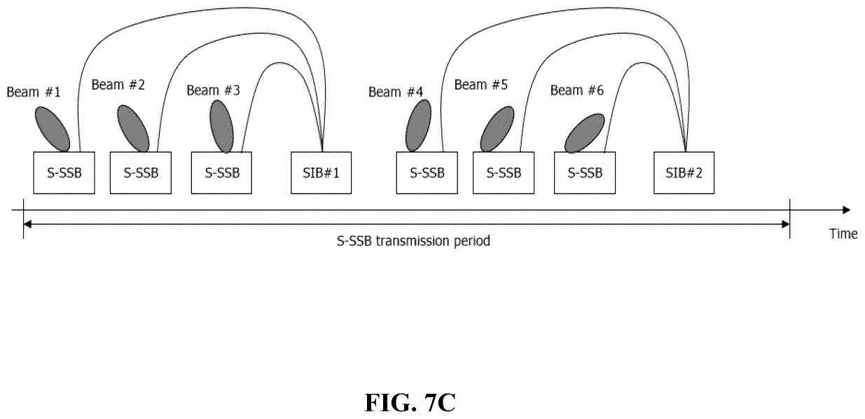

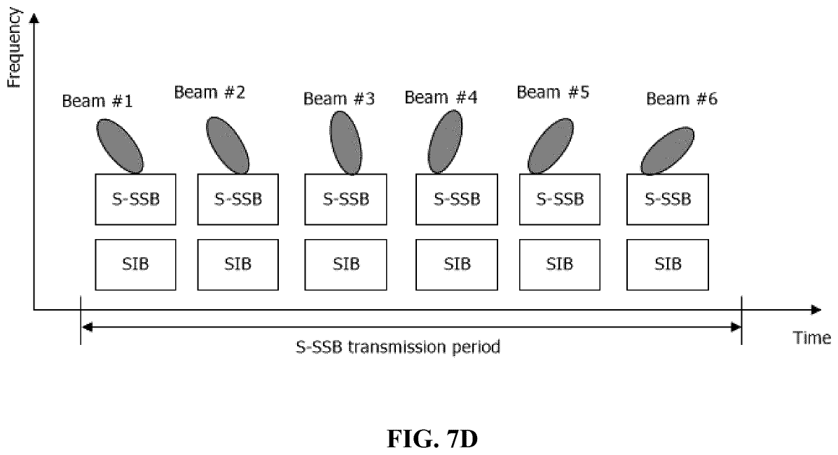

FIGS. 7A to 7D Illustrate Examples of Performing Beam Sweeping within an S-SSB Transmission Period According to an Embodiment of the Present Specification.

FIG. 7A illustrates an example where UE1 performs beam sweeping transmission of four S-SSBs with four beams within an S-SSB transmission period. At this time, the MIB transmitted via the PSBCH within the S-SSB includes SIB transmission resource information, and UE1 may include all or part of the aforementioned identifier information in the SIB and transmit it using that resource. At this time, the SIB transmission resource information may be the same in the MIB of each S-SSB.

FIG. 7B is an example of performing beam sweeping twice for S-SSB transmission using three beams within an S-SSB transmission period. In this example, the SIBs may be transmitted respectively after one beam sweeping is completed. In this case, the MIB transmitted via beams #1, #2, and #3 in the first beam sweeping may indicate/include the resource information of SIB #1. The MIB transmitted via beams #1, #2, and #3 in the second beam sweeping may indicate/include the resource information of SIB #2. At this time, the identifier information transmitted via SIB #1 and SIB #2 may be the same.

FIG. 7C is an example of sweeping once for S-SSB transmission using six beams within an S-SSB transmission period. In FIG. 7C, an SIB may be transmitted after S-SSB transmission with a specific number of beams within an S-SSB transmission period. This specific number may be configured in a resource pool specific, SL specific, or UE specific manner. The configured value for this specific number may be explicitly configured via RRC, MAC-CE, or the MIB within the PSBCH. Alternatively, since the transmission location of the SIB may be indicated according to the resource information indicated via the MIB within the PSBCH, it may be operated without configuring this specific value. In FIG. 7C, the MIB transmitted via beams #1, #2, and #3 may indicate/include the resource information of SIB #1. The MIB transmitted via beams #4, #5, and #6 may indicate/include the resource information of SIB #2. At this time, the identifier information transmitted via SIB #1 and SIB #2 may be the same.

The SIB transmitted in the example of FIG. 7A, FIG. 7B, and/or FIG. 7C described above may be transmitted with an omni-beam. Alternatively, the SIB may be repeated on a slot or symbol basis and transmitted in a beam sweeping manner during SIB transmission for each resource unit.

Meanwhile, FIG. 7D is an example of sweeping once for S-SSB transmission using six beams within an S-SSB transmission period. At this time, the locations of the SIBs may be configured with a specific frequency offset value based on the S-SSB transmission resource and transmitted with the same beam as each S-SSB at a fixed location. The specific frequency offset value may be fixed and configured system-wise, and may be configured and operated in an SL specific or resource pool specific manner.

In the examples of FIG. 7A, FIG. 7B, FIG. 7C, and/or FIG. 7D, transmission via PSCCH and PSSCH may be used instead of the SIB format to transmit the identifier information.

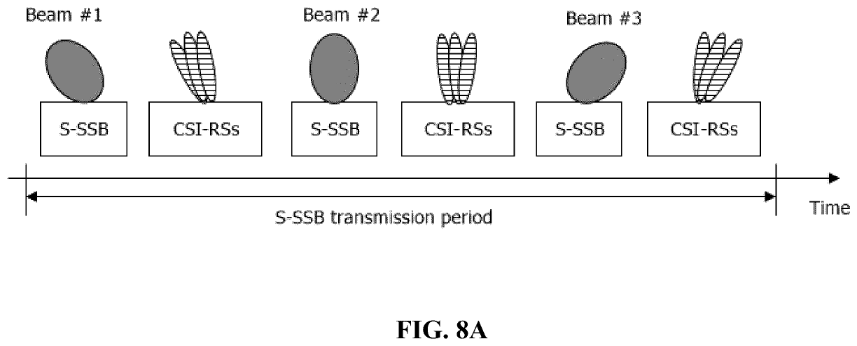

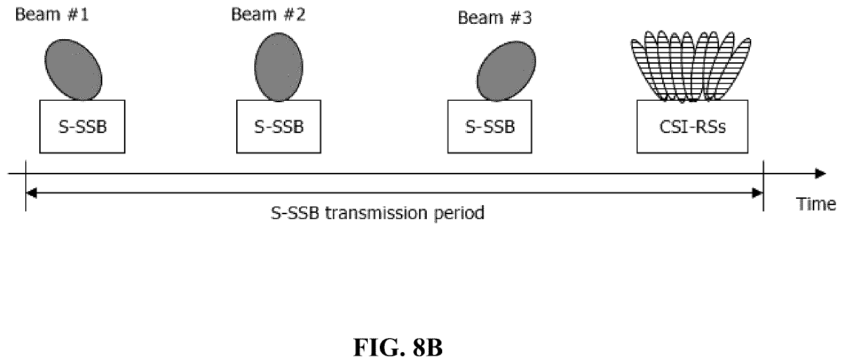

FIGS. 8A to 8B Illustrate Examples where a Standalone CSI-RS is Transmitted in Conjunction with S-SSB Beam Sweeping According to an Embodiment of the Present Specification.

In the case where the RS transmitted in the example of FIG. 6A and/or FIG. 6B is transmitted together with S-SSB and SL CSI-RS, a standalone CSI-RS may be transmitted in conjunction with the S-SSB beam sweeping. FIG. 8A is an example of this method. It is assumed that three S-SSBs are transmitted via beam sweeping within an S-SSB transmission period. And it is an example where the location of the CSI-RS transmission resource is configured/fixed and operated by setting time and frequency resource offset values based on the time and frequency resource location of each S-SSB. The offset value of the time/frequency resource where the CSI-RS is transmitted based on the S-SSB resource location, or the configuration for a specific time/frequency resource location, may be fixed and configured system-wise, and may be indicated via the MIB of the S-SSB. Alternatively, it may be indicated via RRC/MAC-CE, etc. This configuration may be set and operated in an SL specific or resource pool specific manner. In the example of FIG. 8A, the transmission beam of the S-SSB may be composed of a beam with a wider beam width compared to the CSI-RS transmission beam. Furthermore, the CSI-RS beam transmitted after each S-SSB may be configured and used as a narrow beam within the S-SSB transmission beam width immediately before the CSI-RS transmission. This example shows an operation where a CSI-RS is composed of three symbols, and the CSI-RS transmitted through each symbol is transmitted with a different beam. The size of the resource for transmitting the CSI-RS, for example, the number of symbols or slots used, may be indicated via MIB or RRC/MAC-CE, etc., and may be configured and operated in an SL specific or resource pool specific manner. In the example of FIG. 8A, after successfully receiving a specific S-SSB, UE2 may acquire beam pairing information through the successfully received S-SSB and the CSI-RSs transmitted thereafter. At this time, the identifier information may be acquired in the same form as in the example of FIG. 7A, FIG. 7B, and/or FIG. 7C.

FIG. 8B assumes that three S-SSBs are transmitted via beam sweeping within an S-SSB transmission period. Unlike FIG. 8A, it is an example where the CSI-RS is transmitted continuously after all S-SSBs have been transmitted via beam sweeping. In this example, the CSI-RS transmission resource may be configured and operated in the same way as in the example of FIG. 8A. In this example, the CSI-RS is transmitted with 9 different beams using 9 symbols. After successfully receiving a specific S-SSB, UE2 may acquire beam pairing information through the successfully received S-SSB and the CSI-RSs transmitted thereafter. At this time, the identifier information may be acquired in the same form as in the example of FIG. 7A, FIG. 7B, and/or FIG. 7C.

In the examples of FIGS. 8A to 8B, some or all of the CSI-RS transmission beams may be transmitted with the same beam, and the CSI-RSs transmitted with the same beam may be utilized for measurement purposes for UE2's reception beam configuration.

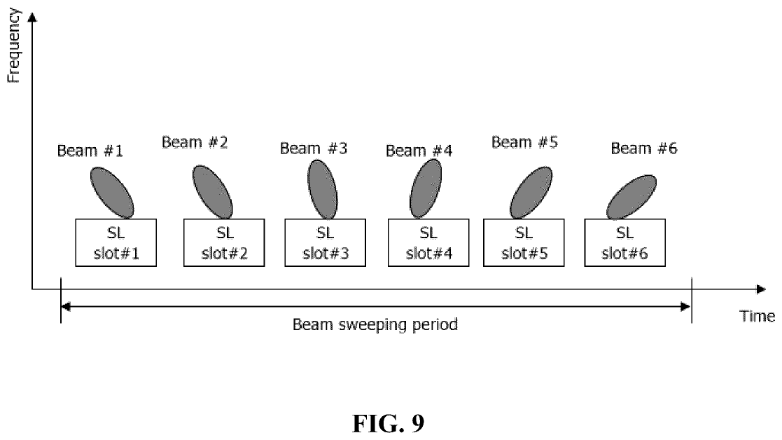

FIG. 9 Illustrates an Example where a Sidelink Slot is Transmitted in a Beam Sweeping Manner Via Six Beams During One Beam Sweeping Period According to an Embodiment of the Present Specification.

In the case where the RS transmitted in the example of FIG. 6A and/or FIG. 6B transmits PSCCH and PSSCH and CSI-RS or DM-RS within an SL slot, multiple SL slots may be transmitted in a beam sweeping manner within a beam sweeping period. At this time, the beam sweeping period may be indicated via MIB or SIB or RRC/MAC-CE, etc., and may be configured and operated in an SL specific or resource pool specific manner.

FIG. 9 is an example where an SL slot is transmitted in a beam sweeping manner via 6 beams during one beam sweeping period.

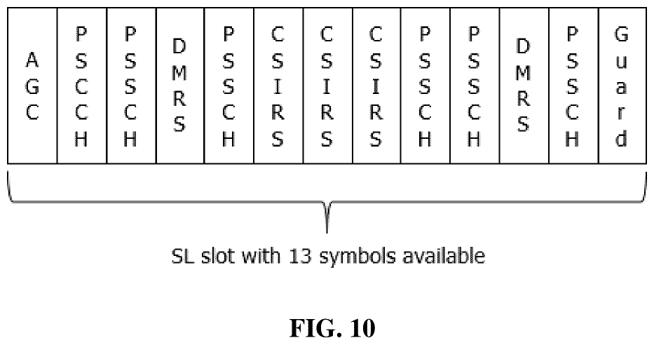

### FIG. 10 Illustrates an Example of a Sidelink Slot Configuration According to an Embodiment of the Present Specification.

Referring to FIG. 10, a slot composed of 13 symbols is configured with 1 automatic gain control (AGC) symbol, 1 PSCCH symbol, 5 PSSCH symbols, 1 guard symbol, 2 DM-RS symbols, and 3 CSI-RS symbols. In this SL slot, the number of PSSCH symbols, the number of DM-RS symbols, and the number of CSI-RS symbols may be configured in various forms.

One SL slot may be composed of only PSCCH and DM-RS, including an AGC symbol and a guard symbol. Alternatively, an SL slot may be composed of only PSCCH and CSI-RS. Alternatively, it may be composed of only PSCCH and PSSCH and DM-RS. Alternatively, it may be composed of only PSCCH and PSSCH and CSI-RS. At this time, in an SL slot composed of only PSCCH and CSI-RS and an SL slot composed of only PSCCH and PSSCH and CSI-RS, a DM-RS for PSCCH and PSSCH decoding may be included.

In the example of FIG. 10, it is assumed that the CSI-RS or DM-RS are all transmitted with the same beam. Therefore, within one SL slot, UE2 may change its reception beam and perform measurement for the same beam, and based on this, it is possible to acquire information about the transmission/reception beam pair for UE1 and UE2.

In the example of FIG. 10, some DM-RS or some CSI-RS transmitted within an SL slot may be transmitted with a different beam from the DM-RS for decoding PSCCH, PSSCH, and PSCCH and PSSCH. In this case, the UE may perform measurement for multiple UE1 TX beams within one SL slot. At this time, the identifier information can be transmitted via SCI of the PSCCH, PSSCH, or MAC-CE.

The disclosure proposed in this specification and the examples of FIGS. 7a to 10 may be operated in a simply extended, modified, or combined form.

Hereinafter, an apparatus to which the present specification may be applied will be described.

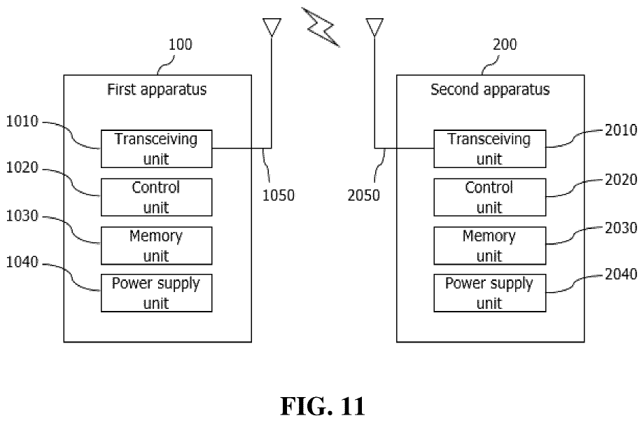

### FIG. 11 Illustrates a Wireless Communication Apparatus According to an Embodiment of the Present Specification.

Referring to FIG. 11, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method for a transmitting terminal to perform sidelink communication, the method comprising:
transmitting a reference signal (RS) for beam pairing;
receiving a beam reporting based on the transmitted RS;
transmitting a direct link establishment request (DCR) message based on the received beam reporting; and
receiving a direct link establishment accept (DCA) message in response to the transmitted DCR message.

2. The method of claim 1, wherein the DCR message includes a beam pairing response.

3. The method of claim 1, wherein the DCR message is transmitted based on a predetermined time offset.

4. The method of claim 1, wherein the RS comprises at least one of a sidelink-synchronization signal block (S-SSB), a sidelink channel state information-reference signal (CSI-RS), or a demodulation-reference signal (DM-RS) of a sidelink channel.

5. The method of claim 1, wherein the RS includes identifier information of the transmitting terminal and/or a receiving terminal.

6. A method for a receiving terminal to perform sidelink communication, the method comprising:
receiving a reference signal (RS) for beam pairing;
transmitting a beam reporting based on the received RS;
receiving a direct link establishment request (DCR) message based on the transmitted beam reporting; and
transmitting a direct link establishment accept (DCA) message in response to the received DCR message.

7. The method of claim 6, wherein the DCR message includes a beam pairing response.

8. The method of claim 6, wherein the DCR message is received based on a predetermined time offset.

9. The method of claim 6, wherein the RS comprises at least one of a sidelink-synchronization signal block (S-SSB), a sidelink channel state information-reference signal (CSI-RS), or a demodulation-reference signal (DM-RS) of a sidelink channel.

10. The method of claim 6, wherein the RS includes identifier information of a transmitting terminal and/or the receiving terminal.

11. A transmitting terminal for performing sidelink communication, comprising:
a control unit; and
a memory unit storing instructions and being operably and electrically connectable to the control unit, wherein operations performed based on the instructions being executed by the control unit comprise:
transmitting a reference signal (RS) for beam pairing;
receiving a beam reporting based on the transmitted RS;
transmitting a direct link establishment request (DCR) message based on the received beam reporting; and
receiving a direct link establishment accept (DCA) message in response to the transmitted DCR message.

12. The transmitting terminal of claim 11, wherein the DCR message includes a beam pairing response.

13. The transmitting terminal of claim 11, wherein the DCR message is transmitted based on a predetermined time offset.

14. The transmitting terminal of claim 11, wherein the RS comprises at least one of a sidelink-synchronization signal block (S-SSB), a sidelink channel state information-reference signal (CSI-RS), or a demodulation-reference signal (DM-RS) of a sidelink channel.

15. The transmitting terminal of claim 11, wherein the RS includes identifier information of the transmitting terminal and/or a receiving terminal.

16. A receiving terminal for performing sidelink communication, comprising:
a control unit; and
a memory unit storing instructions and being operably and electrically connectable to the control unit,
wherein operations performed based on the instructions being executed by the control unit comprise:
receiving a reference signal (RS) for beam pairing;
transmitting a beam reporting based on the received RS;
receiving a direct link establishment request (DCR) message based on the transmitted beam reporting; and
transmitting a direct link establishment accept (DCA) message in response to the received DCR message.

17. The receiving terminal of claim 16, wherein the DCR message includes a beam pairing response.

18. The receiving terminal of claim 16, wherein the DCR message is received based on a predetermined time offset.

19. The receiving terminal of claim 16, wherein the RS comprises at least one of a sidelink-synchronization signal block (S-SSB), a sidelink channel state information-reference signal (CSI-RS), or a demodulation-reference signal (DM-RS) of a sidelink channel.

20. The receiving terminal of claim 16, wherein the RS includes identifier information of a transmitting terminal and/or the receiving terminal.
